(19) United States
(12) Patent Application Publication
(10) Pub. No.: US 2006/0193402 A1
(43) Pub. Date: Aug. 31, 2006

(54) Frequency shift keying receiver for minimum shift keying, and a method for setting reference PN sequence for frequency shift keying thereof

(75) Inventor: U. Sang Lee, Suwon (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 11/305,018

(22) Filed: Dec. 19, 2005

(30) Foreign Application Priority Data
Feb. 28, 2005 (KR) 10-2005-16526

(51) Int. Cl. H04L 27/14

(52) U.S. Cl. 375/336

(57) ABSTRACT

The invention relates to an FSK receiver for MSK capable of transmitting an MSK-modulated signal via FSK demodulation, and a method for setting a plurality of reference PN sequences thereof. In the FSK receiver for MSK of the invention, an RF converter converts an MSK-modulated RF signal into an IF signal. An FSK receiver FSK-demodulates the IF signal into a chip signal. Also, a correlation array includes an FSK PN sequence table comprising a plurality of reference PN sequences having a plurality of FSK reference chip signals. The correlation array collects the chip signal from the FSK receiver to generate a plurality of PN sequences having a plurality of chip signals, and correlating the generated PN sequences with each of the reference PN sequences to restore raw data. The invention provides the method for setting the plurality of FSK reference PN sequences in the FSK receiver for MSK.

### CLAIM OF PRIORITY

This application claims the benefit of Korean Patent Application No. 2005-16526 filed on Feb. 28, 2005, in the Korean Intellectual Property Office, the disclosure of which is incorporated herein by reference.

### BACKGROUND OF THE INVENTION

1. Field of the Invention

The present invention relates to a Frequency Shift Keying (FSK) receiver for Minimum Shift Keying (MSK) for receiving an MSK-modulated signal employed in a Zigbee device of a telecommunication system. More particularly, the present invention relates to an FSK receiver for MSK capable of receiving an MSK-modulated signal via FSK demodulation, and setting new reference PN sequences in the FSK receiver for the purpose thereof, and a method for setting the reference PN sequences of the FSK receiver for MSK.

2. Description of the Related Art

Generally, an MSK signal is generated via Offset Quadrature Phase Shift Keying (OQPSK) adopting a sine filter as a pulse shaping filter. A Minimum Shift Keying (MSK) signal generated according to polarity of the sine filter can be categorized into type 1 and type II. Type I uses the sine filter, whereas type II undergoes filtering after placing an absolute value on sine. Due to this difference, type I and type II of MSK are starkly contrasted in terms of inputted data and frequencies of generated signals.

A key system employing the MSK modulation includes a Zigbee device, which is characterized by lower cost (less than 2$), lower power (less than 1 mW) and lower data transmission rate than a Bluetooth device. Thus, the Zigbee device is very likely to serve as a core technology of wireless communications to prepare for the upcoming age of ubiquitous computing. The Zigbee device applies different communication standards to a physical layer and data link layer (an MAC layer) in accordance with the type of frequencies used: 868/915 MHz and 2.4 GHz.

The MSK receiver used in the Zigbee device will be explained with reference to FIG. 1.

FIG. 1 is a configuration of a conventional MSK receiver. The conventional MSK receiver includes an RF converter 110 for separating received MSK signals via an antenna into I and Q channels to convert signals of each channel into baseband signals I,Q, an MSK receiver 120 for MSK-demodulating the baseband signals I,Q from the RF converter 110 into parallel signals of I and Q chips IC,QC; a P/S decoder 130 for converting the parallel signals of I and Q chips IC, QC from the MSK receiver 120 into serial chip signals CS, and a correlation array 140 for restoring raw data based on the serial chip signals CS from the PS decoder 130.

The conventional MSK receiver, with OQPSK modulation being performed in a transmitter, requires received signals to be separated into I and Q channels for processing, which will be explained in reference to FIG. 2.

FIG. 2 is an internal configuration of the RF converter of FIG. 1. Referring to FIG. 2, the RF converter 110 includes an I/Q distributor 111 for separating an RF signal into I and Q channels, an RF mixer 112 for converting RF signals of I and Q channels from the I/Q distributor 111 into I-IF and Q-IF signals respectively, a bandpass filter 113 for bandpassing I-IF and Q-IF signals from the RF mixer 112, an IF mixer 114 for converting I-IF and Q-IF signals from the bandpass filter 113 into I and Q baseband signals I,Q, and a lowpass filter 115 for lowpassing the I and Q baseband signals I,Q from the IF mixer 114.

The RF converter 110 of the conventional MSK receiver should separate input signals into I and Q channels to process, and thereby be designed and manufactured as a complex circuit.

A Zigbee device, as stated above, applies different telecommunication standards to a physical layer and a data link layer (an MAC layer) according to a type of frequencies used: 868/915 MHz and 2.4 GHz. A brief explanation will be given hereunder regarding MSK modulation process based on Direct Sequence Spread Spectrum (DSSS) in an MSK transmitter using a 2.4 GHz frequency.

First, binary raw data is grouped into 4-bit data. Each 4-bit data is mapped into one of 16 PN sequences (each PN sequence having 32 chip signals) in a preset MSK PN sequence table. A chip signal in the mapped PN sequences is MSK-modulated (e.g., by sine filtered O-QPSK).

Since modulation is conducted via sine-filtered O-QPSK, the MSK receiver should separate received signals into I and Q channels in accordance with DSSS-based MSK. Also, in reference to 16 PN sequences prepared in advance in the MSK PN sequence table, the received signals should be restored into raw data.

FIG. 3 illustrates operation of the P/S decoder of FIG. 1. Referring to FIG. 3, the P/S decoder 130, as identified above, converts an I chip signal IC and a Q chip signal QC from the MSK receiver 120 into serial chip signals CS. For example, if the I chip signal IC includes IC1,IC2 and IC3, and the Q chip signal QC includes QC1,QC2 and QC3, the QC1,QC2 and QC3 are inserted between the IC1,IC2 and IC3 to output serial chip signals of IC1,QC1,IC2,QC2,IC3 and QC3.

FIG. 4 is a diagram of a PN sequence table for MSK in the correlation array of FIG. 1. As shown in FIG. 4, the correlation array 140 includes an MSK PN sequence table MPT. The MSK PN sequence table for MSK MPT includes 16 MSK reference PN sequences R-PNC1 to R-PNC16 and each reference PN sequence includes 32 chip signals ch1-ch32, as shown in FIG. 4.

First, the correlation array 140 collects chip signals from the P/S decoder 130 to group the collected chip signals by 32 into a PN sequence. Then, the correlation array multiplies 32 chip signals of each PN sequence by 32 chip signals in 16 reference PN sequences of the pre-set PN sequence table 145, and adds the results to obtain sums for each of the PN sequences. Lastly, the correlation array 140 finds the maximum value out of the sums for each of the PN sequences to execute a process of restoring raw data so that a PN sequence corresponding to the maximum value is determined as raw data.

However, since the conventional MSK receiver processes I and Q signals with an independent circuit and the OQPSK-based MSK receiver requires baseband signals, an Intermediate Frequency (IF) mixer should be necessarily implemented. This complicates the circuit of the RF converter and requires conversion of the separated I and Q channels into serial signals, and thereby a P/S decoder should be necessarily implemented.

Furthermore, due to a requirement to implement complicated and high-cost O-QPSK-based MSK receiver, there arises a problem of increased size and price of an MSK receiver.

To overcome the problem, the MSK signals may be interpreted via Frequency Shift Keying (FSK) besides OQPSK. But even if interpreted via FSK, transmitted data cannot be received just by observing only frequencies of the received signals as in the conventional FSK receiver. Therefore reception via FSK is in fact impossible.

### SUMMARY OF THE INVENTION

The present invention has been made to solve the foregoing problems of the prior art and it is therefore an object of the present invention to provide a Frequency Shift Keying (FSK) receiver for Minimum Shift Keying (MSK) capable of receiving an MSK-modulated signal via FSK demodulation.

It is another object of the invention to provide a method for setting reference PN sequences for frequency shift keying to receive an MSK-modulated signal via FSK demodulation.

According to an aspect of the invention for realizing the object, there is provided an FSK receiver for MSK, the receiver comprising:

an RF converter for converting an MSK-modulated RF signal into an IF signal;

an FSK receiver for FSK-demodulating the IF signal into a chip signal; and

a correlation array including an FSK PN sequence table comprising a plurality of reference PN sequences having a plurality of FSK reference chip signals, the array for collecting the chip signal from the FSK receiver to generate a plurality of PN sequences having a plurality of chip signals, and correlating the generated PN sequences with each of the reference PN sequences to restore raw data.

The RF converter comprises an RF mixer for mixing the RF signal with a pre-set oscillation frequency signal; and a bandpass filter for passing a mixed signal from the RF mixer through a pre-set frequency band to output the IF signal.

The correlation array comprises a PN sequence collector for collecting the chip signal from the FSK receiver to generate the PN sequences having a plurality of chip signals; a multiplier for multiplying the chip signals of the generated PN sequences by corresponding reference chip signals of the reference PN sequences in the PN sequence table for FSK, respectively; an adder for adding results multiplied by the multiplier for each of the PN sequences to obtain sums for each of the PN sequences; a maximum value producer for producing a maximum value out of the sums of the adder; and a restorer for restoring a reference PN sequence corresponding to the maximum value into raw data.

Furthermore, a method for setting reference PN sequences for Frequency Shift Keying (FSK) in the correlation array of an FSK receiver for Minimum Shift Keying (MSK) of the invention to receive MSK type II or type I modulated signals via FSK demodulation, the method comprising steps of:

(a) receiving pre-set reference PN sequences of the MSK type II or type I;

(b) judging the received MSK type, if judged as the MSK type II, operating reference PN sequences of the received MSK type II with a pre-set conversion code to convert into reference PN sequences of the MSK type I;

(c) if judged as the MSK type I or converted into the MSK type I via the step (b), converting the reference PN sequences of the MSK type I into reference PN sequences of FSK type; and

(d) storing the reference PN sequences of the FSK type in an FSK PN sequence table.

In the MSK type converting step (b), the pre-set conversion code is made of 4 bits. The MSK type converting step (b) comprises implementing 4-bit operation on the 4-bit conversion code to convert the reference PN sequences of the MSK type II into the reference PN sequences of the MSK type I.

The MSK/FSK converting step (c) comprises implementing differential operation on the reference PN sequences of the MSK type I to convert into the reference PN sequences of the FSK type.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a configuration of a conventional MSK receiver 1;

FIG. 2 is an internal configuration of an RF converter of FIG. 1;

FIG. 3 is diagram illustrating operation of a P/S decoder of FIG. 1;

FIG. 4 is a PN sequence table of a correlation array of FIG. 1;

FIG. 5 is a configuration of an FSK receiver for MSK of the invention;

FIG. 6 illustrates the FSK PN sequence table of a correlation array of FIG. 5;

FIG. 7 is an internal configuration of a correlation array of FIG. 5;

FIG. 8 is a diagram illustrating operation of a multiplier of FIG. 7;

FIG. 9 is a diagram illustrating operation of an adder of FIG. 7;

FIG. 10 is a flowchart showing a method for setting reference PN sequences of the invention; and

FIG. 11 is a block diagram of the method for setting the reference PN sequences of the invention.

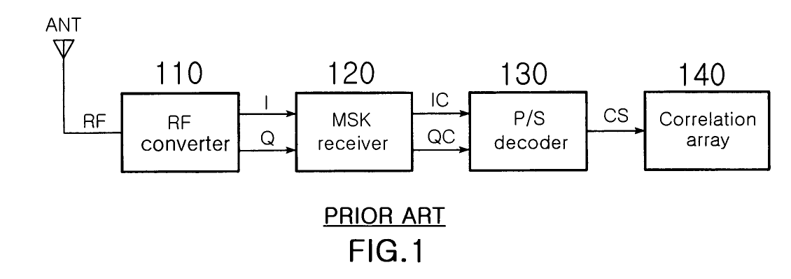

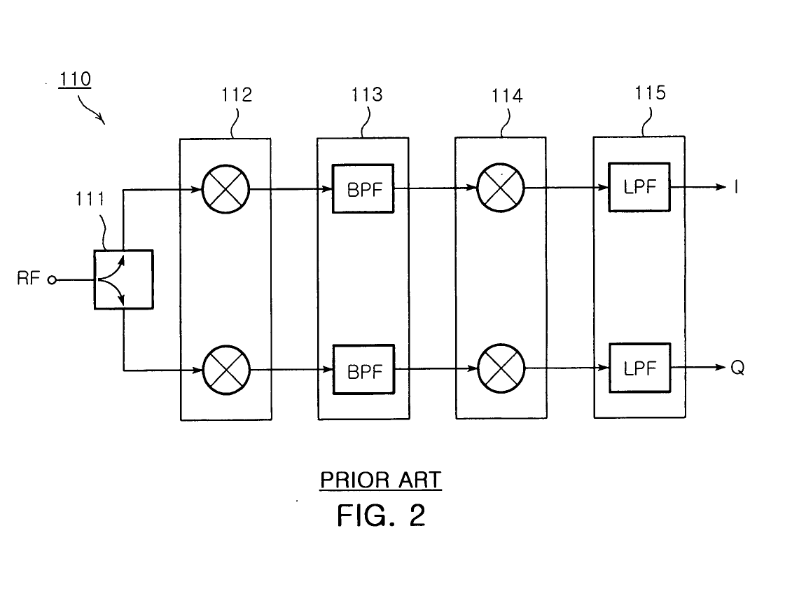

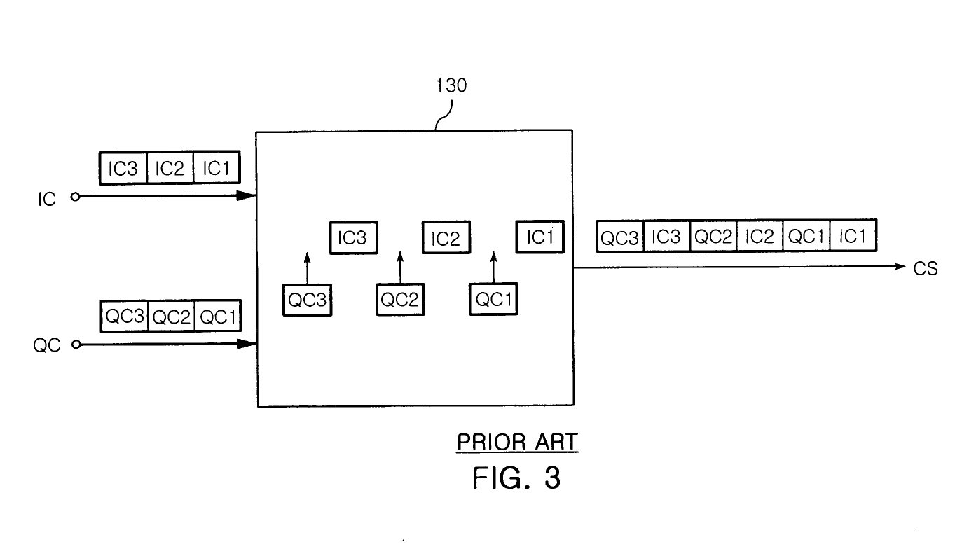

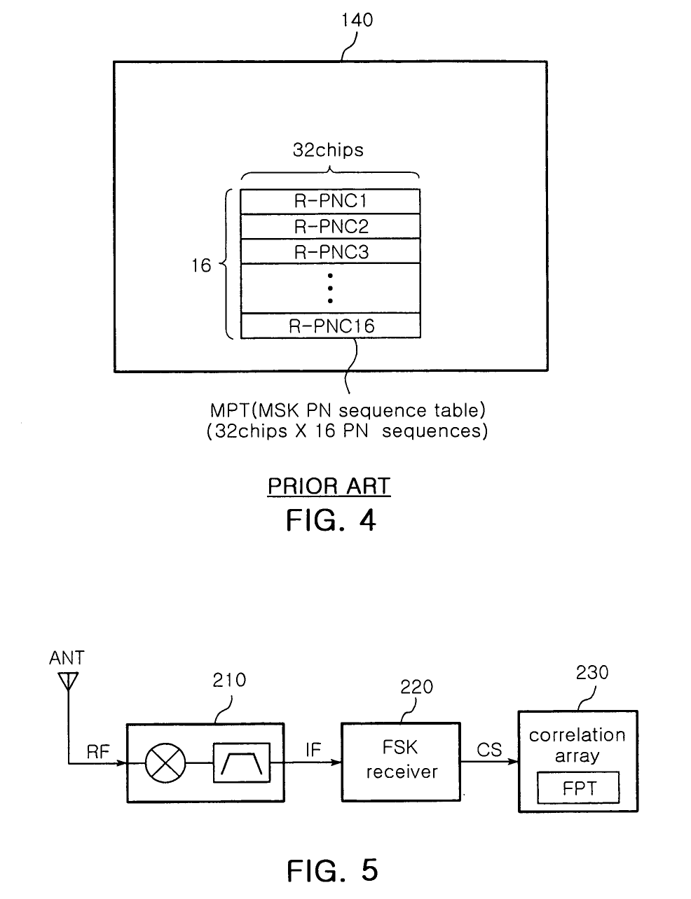

### DETAILED DESCRIPTION OF THE PREFERRED EMBODIMENT

Preferred embodiments of the present invention will now be described in detail with reference to the accompanying drawings, in which the reference numerals are used throughout the different drawings to designate the same or similar component.

The invention employs conversion relations between the afore-mentioned MSK types and applies in advance a differential operation, which has not been usable in real environment due to propagated error in executing a conversion operation, to a spreading code, thereby avoiding propagated error. As a result, an MSK signal can be an FSK receiver just by substituting the reference PN sequences for remapping into a raw signal with new reference PN sequences in the receiver.

FIG. 5 shows a configuration of an FSK receiver for MSK of the invention. Referring to FIG. 5, the FSK receiver for MSK includes an RF converter 210 for converting a 2.4 GHz RF signal modulated into MSK type II or type I to convert into an IF signal, an FSK receiver 220 for FSK-demodulating the IF signal IF from the RF converter 210 into a chip signal CS, and a correlation array 230 including an FSK PN sequence table FPT having pre-set FSK reference PN sequences. The array 230 collects the chip signal CS from the FSK receiver to generate a plurality of PN sequences having a plurality of chip signals, and correlates the generated PN sequences with each of the reference PN sequences in the FSK PN sequence table FPT to restore raw data.

The RF converter 210 includes an RF mixer 211 for mixing a 2.4 GHz RF signal RF with a pre-set oscillation frequency signal and a bandpass filter 212 for passing a mixed signal from the RF mixer through a pre-set frequency band to output the IF signal IF.

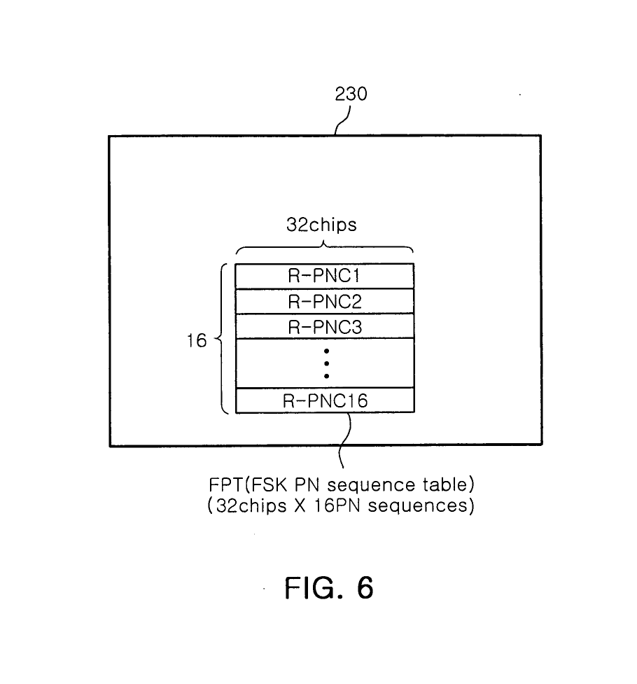

FIG. 6 is a diagram showing an FSK PN sequence table of the correlation array of FIG. 5. Referring to FIG. 6, the FSK PN sequence table FPT includes 16 reference PN sequences for FSK R-PNC1 to R-PNC16, each of which is made of 31 chip signals (31 bits).

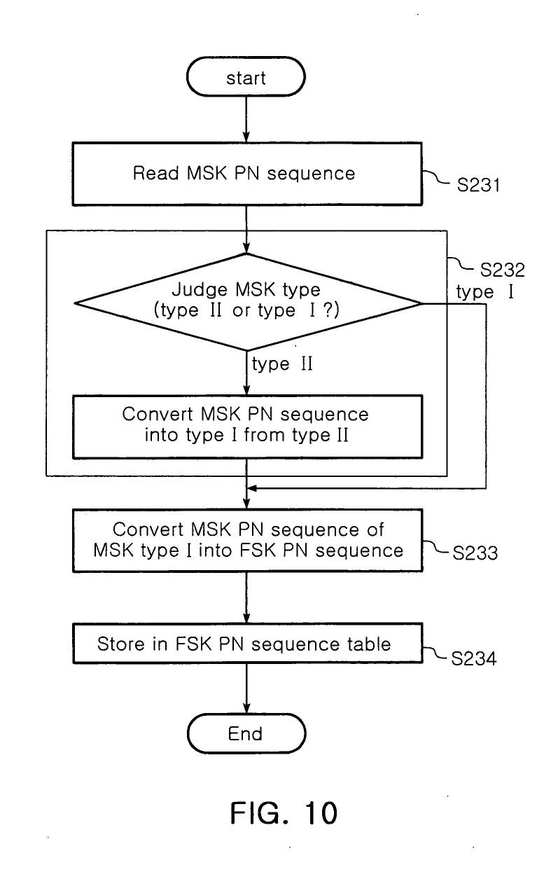

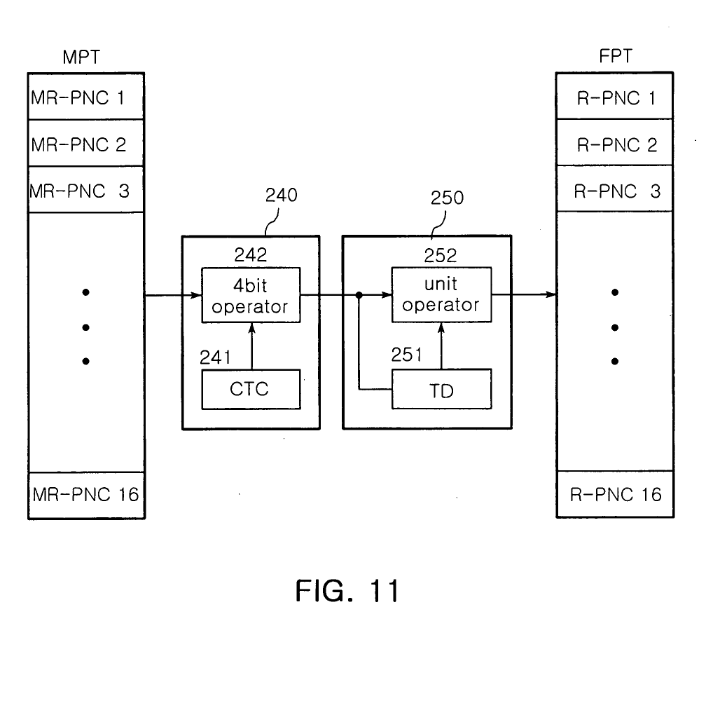

The reference PN sequences for FSK are converted and set through a predetermined process in the pre-set reference PN sequences for MSK, which will be explained hereunder with reference to FIG. 10 and FIG. 11.

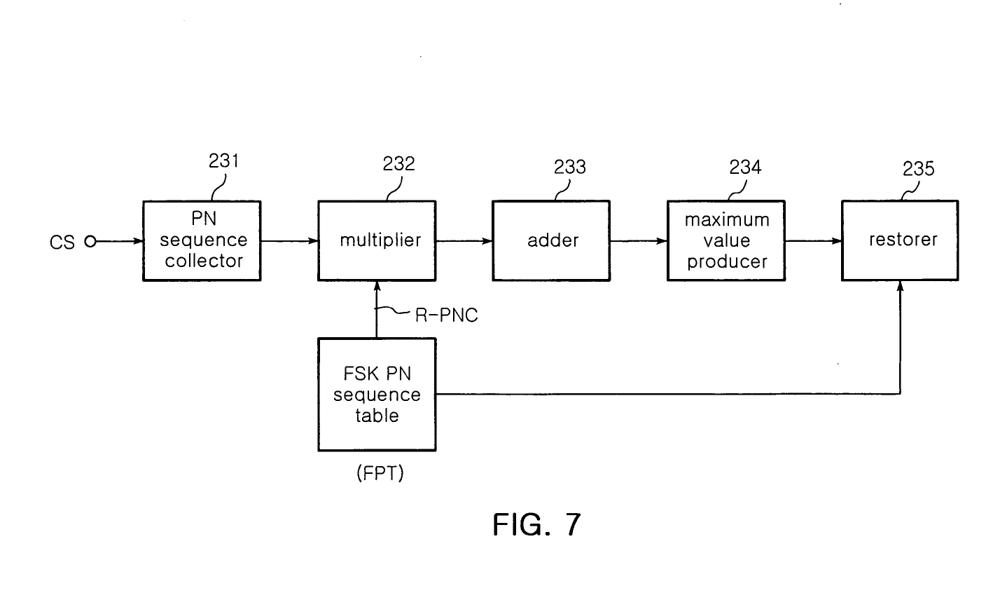

FIG. 7 is an internal configuration of FIG. 5. As shown in FIG. 7, the correlation array 230 includes a PN sequence collector 231 for collecting the chip signal CS from the FSK receiver 220 to generate the PN sequences PNC having 32 chip signals, a multiplier 232 for multiplying the chip signals of the generated PN sequences by corresponding reference chip signals of the reference PN sequences R-PNC in the FSK PN sequence table FPT, respectively, an adder 233 for adding results CV multiplied by the multiplier for each of the PN sequences to obtain sums PV for each of the PN sequences, a maximum value producer 234 for producing a maximum value out of the sums PV of the adder 233, and a restorer for restoring a reference PN sequence corresponding to the maximum value into raw data.

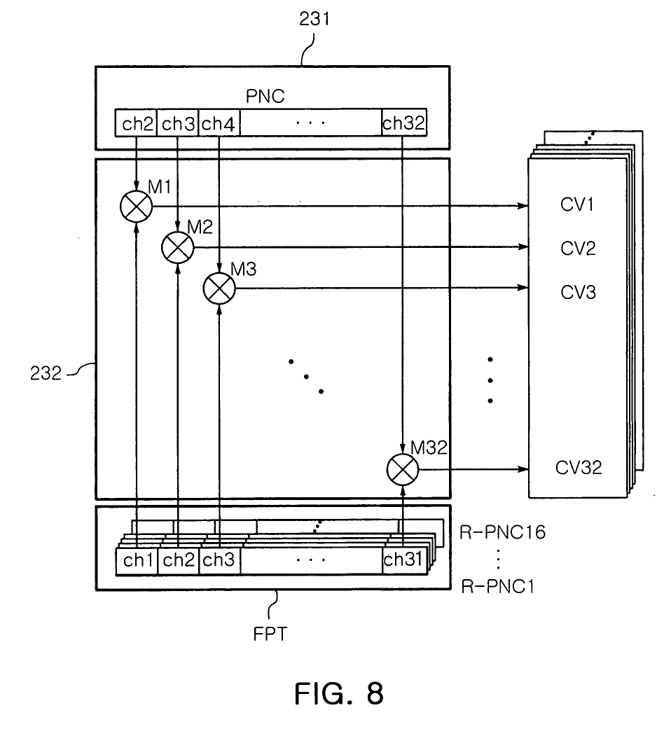

FIG. 8 illustrates operation of the multiplier of FIG. 7. As shown in FIG. 8, the multiplier 232 includes a plurality of multipliers M1-M31 for multiplying the chip signals ch2-ch32 of the PN sequences PNC generated by the PN sequence collector 231 by the corresponding reference chip signals ch1-ch31 of the reference PN sequences R-PNC in the FSK PN sequence table FPT, respectively and outputting the results CV1-CV31. Herein, the first chip signal ch1 of each PN sequence is excluded from multiplication. That is because chip signals necessary for multiplication should not be relevant to previous chip signals but the first chip signal ch1 of each PN sequence is relevant to previous chip signals due to differential operation.

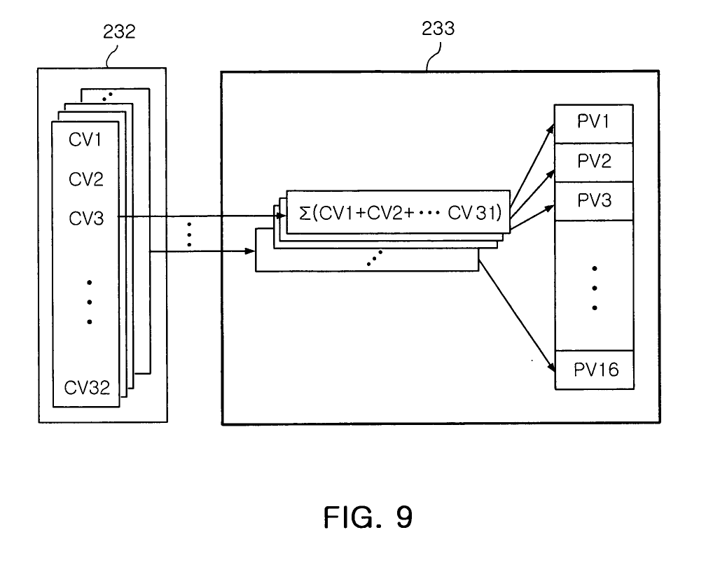

FIG. 9 illustrates operation of the adder of FIG. 7. As shown in FIG. 9, the adder 233 adds the results CV1-CV31 multiplied by the multiplier 232 for each of the PN sequence to output sums PV for each of the PN sequences. The sums PV for each PN sequence are made of a plurality of sums PV1-PV16 corresponding to the plurality of PN sequences.

The operation and effects of the invention will be explained hereunder with reference to the attached drawings.

The FSK receiver for MSK of the invention receives signals modulated into DSSS-based MSK type II or type I, and a Zigbee protocol can be applied thereto.

With reference to FIG. 5 and FIG. 6, the FSK receiver for MSK of the invention will be explained hereunder. As shown in FIG. 5, the RF converter 210 of the FSK receiver for MSK converts an RF signal modulated into MSK type II or type I into an IF signal IF and outputs the same to the FSK receiver 220.

The FSK receiver 220 FSK-demodulates the IF signal from the RF converter 210 into a chip signal, which is then outputted to the correlation array 230. A conventional FSK demodulation is applied to FSK-demodulate the If signal from the FSK receiver 220 of the invention. FSK demodulation includes Limiter Discriminator Integrator (LDI) or Zero Crossing Detector (ZXD)

As shown in FIG. 6, the correlation array 230 includes the FSK PN sequence table FPT having pre-set reference PN sequences for FSK. The correlation array collects the chip signal CS from the FSK receiver 220 to generate a plurality of PN sequences PNC, and correlates the generated PN sequences PNC with each of the reference PN sequences R-PNC in the FSK PN sequence table FPT to restore raw data.

The RF converter 210 includes an RF mixer 211 and a bandpass filter 212. The RF mixer 211 mixes the 2.4 GHz RF signal RF with the pre-set oscillation frequency signal to convert into the IF signal IF, which is then outputted by the bandpass filter 212. The bandpass filter 212 passes the IF signal IF from the RF mixer 211 through a pre-set frequency band.

The RF converter 210 of the invention may have much simpler structure than the RF converter 110 of the conventional MSK receiver. That is because the FSK receiver 220 of the invention can process IF signals directly without requiring I and Q signals.

The correlation array 230 correlates the collected chip signals with each of the reference PN sequences and finds the maximum correlation value to restore a PN sequence corresponding to the maximum correlation value into raw data. This will be explained hereunder with reference to FIG. 7.

As shown in FIG. 7, the PN sequence collector 231 of the correlation array 230 collects the chip signal CS from the FSK receiver 220 to generate the plurality of PN sequences PNC having 32 chip signals. The multiplier 232 of the correlation array 230 multiplies the chip signals of the generated PN sequences PNC by corresponding reference chip signals of the reference PN sequences R-PNC in the FSK PN sequence table FPT, respectively. The adder 233 of the correlation array 230 adds results multiplied CV by the multiplier 232 for each of the PN sequences to obtain sums for each of the PN sequences. The maximum value producer 234 of the correlation array 230 produces the maximum value out of the sums PV of the adder 233. The restorer 235 of the correlation array restores a reference PN sequence corresponding to the maximum value into raw data.

As shown in FIG. 8, the multiplier 232 includes a plurality of multipliers M1-M31 for multiplying the chip signals ch2 to ch32 of the PN sequences PNC generated by the PN sequence collector 231 by corresponding reference chip signals ch1-ch31 of the reference PN sequences R-PNC in the FSK PN sequence table FPT, respectively and outputting the results CV1-CV31.

Referring to FIG. 9, the adder 233 adds the results multiplied CV1-CV31 by the multiplier 232 for each of the PN sequences to output sums PV for each of the PN sequences. The sums PV for each of the PN sequences is made of a plurality of sums PV1-PV32 corresponding to the plurality of PN sequences.

Then, a method for setting the reference PN sequences for FSK with respect to the FSK receiver for MSK of the invention will be explained hereunder as shown in FIG. 5 to 11.

First, the correlation array 230 of the FSK receiver for MSK of the invention as shown in FIG. 5 should set the reference PN sequences for FSK to receive MSK type II or I modulated signals via FSK demodulation. The method for setting the reference PN sequences for FSK will be explained hereunder.

FIG. 10 is a flowchart showing a method for setting the reference PN sequences for FSK of the invention, and FIG. 11 is a configuration showing a process of setting the reference PN sequences of the invention.

Referring to FIG. 5 to FIG. 11, in the inputting step S231, pre-set reference PN sequences of MSK type II are inputted.

In the transmission system in which transmission is executed via MSK type II or II, reference PN sequences of MSK type I or MSK type II needed to demodulate MSK type II or I modulated signals has been determined by the protocol. These pre-set reference PN sequences of MSK type II or I are inputted from the MSK PN sequence table MPT, which has been prepared in advance.

Then, in the MSK modulating step S232, upon judging the inputted MSK type, if judged as MSK type II, an operation is implemented on the reference PN sequences MR-RNC of the inputted MSK type II with a pre-set conversion code CTC to convert into the reference PN sequences of MSK type I.

Meanwhile, in brief explanations concerning MSK type, the MSK signals such as signals used in a Zigbee device are generated via Sine-Filtered Offset Quadrature Phase Shift Keying (O-QPSK), the signals generated thereby being equal to those generated via Quadrature. MSK signals generated via Quadrature, as stated above, can be categorized into type I and type II according to Sine Filter applied.

The MSK-type converting step S232, as shown in FIG. 11, can be implemented by an MSK-type converter. The MSK-type converter 240 can include a conversion code register 241 and a 4-bit operator 242. The register 241 includes a 4-bit conversion code (CTC) to convert an MSK PN sequence from type II to type I, and the operator 242 implements 4-bit operation on reference PN sequences MR-PNC of MSK type II from the MSK PN sequence table MPT with a conversion code register 241 to convert into reference PN sequences of MSK type I. This process is executed on the entire reference PN sequences MR-PNC1 to MR-PNC 16 of the MSK PN sequence table MPT, starting from a first reference PN sequence MR-PNC1 upto a sixteenth PN sequence MR-PNCE 16.

Referring to FIG. 10, in the MSK/FSK-converting step S233, if judged as MSK type I in the MSK-type converting step S232 or converted via the MSK-type converting step S232, the reference PN sequences of MSK type I are converted into the reference PN sequences of FSK type. The MSK/FSK conversion process can be implemented via an MSK/FSK converter 250 as shown in FIG. 11.

Referring to FIG. 11, the MSK/FSK converter 250 includes a chip delayer 251 and a unit operator 252. The chip delayer 251 delays reference PN sequences of MSK type I from the MSK type converter 240 by a delay time equal to one chip signal, and the unit operator 252 operates reference PN sequences of MSK type I from the MSK type converter 240 with reference PN sequences of MSK type I delayed by the chip delayer 251 by one bit. The MSK/FSK converter 250 performs differential operation on the reference PN sequences of MSK I from the MSK type converter 240 to convert into the reference PN sequences of FSK type.

Then, in the setting step S234, the reference PN sequences of the FSK type are stored and set in the FSK PN sequence table FPT in the FSK receiver for MSK according to the invention. As a result, the FSK receiver for MSK, to which the invention is applied, takes account of the reference PN sequences of FSK type stored in the FSK PN sequence table FPT to transmit an MSK signal as identified above.

According to the invention as set forth before, the conventional FSK method did not allow reception of the MSK-modulated signal. But with respect to a method of transmitting by mapping data into a preset spreading code sequence like ZigBee device, the MSK-modulated signal can be FSK-received via an FSK receiver for MSK of the invention.

According to the invention as stated above, a signal modulated into MSK type II or type I can be received via FSK demodulation. Therefore the inputted signal can be processed without separation into I/Q channels, enabling simplification of the RF converter. Due to application of an FSK method, unlike quadrature reception based on separation into I/Q channels, frequency offset has low effects, and thereby application of Zigbee protocol is suitable. In addition, the FSK method has another advantage over an MSK method that it is implementable in a simplified way and at low cost.

Moreover, in order to receive MSK type II or type I modulated signals via FSK demodulation, the reference PN sequences for FSK can be set in the FSK receiver for MSK, lowering costs of designing and manufacturing the receiver for receiving MSK type II or type I modulated signals.

While the present invention has been shown and described in connection with the preferred embodiments, it will be apparent to those skilled in the art that modifications and variations can be made without departing from the spirit and scope of the invention as defined by the appended claims.

What is claimed is:

1. A Frequency Shift Keying (FSK) receiver for Minimum Shift Keying (MSK) comprising:
an RF converter for converting an MSK-modulated RF signal into an IF signal;
an FSK receiver for FSK-demodulating the IF signal into a chip signal; and
a correlation array including an FSK PN sequence table comprising a plurality of reference PN sequences having a plurality of FSK reference chip signals, the array for collecting the chip signal from the FSK receiver to generate a plurality of PN sequences having a plurality of chip signals, and correlating the generated PN sequences with each of the reference PN sequences to restore raw data.

2. The FSK receiver for MSK according to claim 1, wherein the RF converter comprises:
an RF mixer for mixing the RF signal with a pre-set oscillation frequency signal; and
a bandpass filter for passing a mixed signal from the RF mixer through a pre-set frequency band to output the IF signal.

3. The FSK receiver for MSK according to claim 1, wherein the correlation array comprises:
a PN sequence collector for collecting the chip signal from the FSK receiver to generate the PN sequences having a plurality of chip signals;
a multiplier for multiplying the chip signals of the generated PN sequences by corresponding reference chip signals of the reference PN sequences in the PN sequence table for FSK, respectively;
an adder for adding results multiplied by the multiplier for each of the PN sequences to obtain sums for each of the PN sequences;
a maximum value producer for producing a maximum value out of the sums of the adder; and
a restorer for restoring a reference PN sequence corresponding to the maximum value into raw data.

4. A method for setting reference PN sequences for Frequency Shift Keying (FSK) in a correlation array of an FSK receiver for Minimum Shift Keying (MSK) to receive MSK type II or type I modulated signals via FSK demodulation, the method comprising steps of:
(a) receiving pre-set reference PN sequences of the MSK type II or type I;
(b) judging the received MSK type, if judged as the MSK type II, operating reference PN sequences of the received MSK type II with a pre-set conversion code to convert into reference PN sequences of the MSK type I;
(c) if judged as the MSK type I or converted into the MSK type I via the step (b), converting the reference PN sequences of the MSK type I into reference PN sequences of FSK type; and
(d) storing the reference PN sequences of the FSK type in an FSK PN sequence table.

5. The method according to claim 4, wherein in the MSK type converting step (b), the pre-set conversion code is made of 4 bits.

6. The method according to claim 5, wherein the MSK type converting step (b) comprises implementing 4-bit operation on the 4-bit conversion code to convert the reference PN sequences of the MSK type II into the reference PN sequences of the MSK type I.

7. The method according to claim 4, wherein the MSK/FSK converting step (c) comprises implementing differential operation on the reference PN sequences of the MSK type I to convert into the reference PN sequences of the FSK type.
